(19) United States
(12) Patent Application Publication
(10) Pub. No.: US 2003/0135989 A1
(43) Pub. Date: Jul. 24, 2003

(54) Electrodes for alkali metal batteries

(76) Inventors: Robert A. Huggins, Stanford, CA (US); Andreas Netz, Kiel (DE)

Correspondence Address: Robert A. Huggins, 824 San Francisco Ct., Stanford, CA, 94305, US

(21) Appl. No.: 10/053,050

(22) Filed: Jan. 19, 2002

(51) Int. Cl. H01M 4/04

(52) U.S. Cl. 29/623.1; 205/59

(57) ABSTRACT

A method to reduce the initial irreversible capacity in an alkali metal-based electrochemical cell, and thus the necessity for the presence of additional alkali metal source material in the cell comprising one or more preliminary reactions performed by either electrochemical or chemical means.

### FIELD OF THE INVENTION

This application relates to improvements in the properties of negative electrodes in alkali metal battery systems and the batteries that contain them.

### BACKGROUND OF THE INVENTION

The alkali metals are elements of the first group of the periodic table, lithium, sodium, potassium, rubidium, cesium and francium. Alkali metal batteries consist of negative electrodes and positive electrodes that are separated by an electrolyte. Their charge and discharge processes involve the transport of the electroactive species (alkali metal ions) through the electrolyte back and forth between the positive and negative electrodes.

Alkali metal batteries are typically constructed in the discharged state. That is, the electroactive alkali metal is initially incorporated in the structure of the positive electrode, rather than the negative electrode. Under these conditions it is typical that both the positive and negative electrode materials are relatively insensitive to air and water vapor, and thus easy to handle. In contrast, the positive and, especially, the negative electrode materials are not stable in air after the battery is charged and some or all of the alkali metal has moved from the positive electrode to the negative electrode. This is why the final assembly of such batteries involves their enclosure in a hermetically sealed container after the introduction of the electrodes and the electrolyte.

When such a battery is electrochemically charged, the alkali metal ions leave the positive electrode, move through the electrolyte, and enter the negative electrode. During discharge this process is reversed.

In both cases, the amount of charge, i.e. the number of alkali metal ions, entering or leaving the negative electrode is the same as the number of ions which enter or leave the positive electrode. Thus the amount of charge entering or leaving the two electrodes is the same, and the reversible charge capacity of the battery is limited by the amount of reversible capacity of the electrode with the lower value of reversible capacity.

The reversible capacity of an electrode is the amount of electrical charge, i.e. electroactive species, that can be repeatedly added to (supplied to), and deleted from (removed from), the electrode during the normal operation of the battery.

Electrodes can also have irreversible capacity. In the case of negative electrodes, for example, the amount of charge, i.e. the number of electroactive species, that can be removed, can be less than that which is supplied.

If, during the initial charging, or chargings, of the battery there is a combination of reversible and irreversible capacity in the negative electrode, this extra, subsequently unusable, capacity must be supplied from other parts of the battery structure, e.g. by the positive electrode, in addition to the reversible capacity. In this example, this means that the size and weight of the positive electrode must be increased to provide for this useless irreversible negative electrode capacity. This is a distinct disadvantage, especially as the specific capacity of positive electrode materials is typically less than half of that of negative electrode materials.

This matter of the reversible and irreversible capacity of negative electrodes in alkali metal battery systems has been discussed in a number of papers in the technical literature, including:

I. A. Courtney and J. R. Dahn, “Electrochemical and In Situ X-Ray Diffraction Studies of the Hi Reaction of Lithium with Tin Oxide Composites”, J. Electrochem.Soc. 144, 2045 (1997)

I. A. Courtney and J. R. Dahn, “Key Factors Controlling the Reversibility of the Reaction of Lithium with SnO₂ and Sn₂BPO₆ Glass”, J. Electrochem.Soc. 144, 2943 (1997)

R. A. Huggins, “Alloy Negative Electrodes for Lithium Batteries Formed In-Situ From Oxides”, Ionics 3, 245 (1997)

R. A. Huggins, “Alloys Formed From Convertible Oxides as Negative Electrodes in Lithium Batteries”, in Batteries for Portable Applications and Electric Vehicles, ed. by C. F. Holmes and A. R. Landgrebe, Electrochemical Society (1997), p.1.

R. A. Huggins, “Lithium Alloy Negative Electrodes Formed From Convertible Oxides”, Solid State Ionics 113-115, 57(1998).

R. A. Huggins, “Lithium Alloy Anodes”, by Robert A. Huggins, in Handbook of Battery Materials, ed. by J. O. Besenhard, Wiley—VCH (1999), p. 359.

R. A. Huggins, “Lithium Alloy Negative Electrodes”, J. Power Sources, 81-82, 13 (1999)

R. A. Huggins, “Negative Electrode Strategies for Lithium Systems”, presented at Phoenix Meeting of the Electrochemical Society, to be published in an Electrochemical Society Proceedings.

R. A. Huggins, “Oxides and Alloys as Negative Electrodes in Lithium Batteries”, presented at Hawaii Battery Conference (HBC98), Big Island, Hawaii, Jan, 1998.

R. A. Huggins, “Composite Microstructure Electrodes for Lithium Systems”, presented at HBC99, Hawaii Battery Conference, Jan. 1999.

R. A. Huggins, “Alloy Negative Electrodes for Lithium Batteries Formed In-Situ From Oxides”, paper presented at Euroconference in Ireland, Sept. 1997. Published in Ionics

R. A. Huggins, “Lithium Alloy Negative Electrodes Formed From Convertible Oxides”, presented at 11th International Conference on Solid State Ionics, Honolulu, Hawaii, Nov. 1997. Published in Solid State Ionics

R. A. Huggins, “Alloys Formed From Convertible Oxides as Negative Electrodes in Lithium Batteries”, presented at Meeting of the Electrochemical Society in Paris.

Current Negative Electrode Technology in Alkali Metal Batteries

Battery systems for the storage of electrical energy may be constructed with alkali metals as the electroactive species. Lithium and sodium are the most common examples.

In the case that the alkali metal is lithium, current negative electrodes typically involve the insertion and extraction of the lithium from graphite and other carbons. The maximum specific capacity of this negative electrode is determined by the amount of lithium that can be inserted into the graphite crystal structure. This is represented by the formula LiC₆, and the-oretically amounts to 372 mAh/g of carbon weight in the negative electrode. Practical values in commercial cells typically fall in the range 300-350 mAh/g.

Alternatives to Current Negative Electrode Materials

There have been a number of attempts to find or develop materials that would have higher capacities, as well as other potential advantages in alkali metal batteries. Lithium-carbons are currently used as negative electrodes in lithium batteries,

Following a surprise announcement by Fujifilm [“Fujifilm Develops New Generation Lithium Ion Secondary Battery—Featuring the World's Largest Capacity and Energy Density”, Internet: http://www.fujifilm.cojp/eng/news_e/nr079.html, Y. Idota, et al., “Tin-Based Amorphous Oxide: A High-Capacity Lithium-Ion-Storage Material”, Science, 276, 1395 (1997), and subsequently also U.S. Pat. No. 5,780,181] one of the approaches that has received a lot of attention recently involves the use of convertible metal oxides in the negative electrodes of lithium batteries. During the charging (lithiation) of the negative electrode lithium reacts with these oxides to produce multiple product materials. One of them being a lithium-containing oxide that is electrochemically irreversible in the battery. This results in irreversible capacity. In addition, one or more other product materials, e.g. a metal or alloy, is formed that can subsequently react reversibly with additional lithium, producing reversible capacity.

Thus the total amount of lithium that is initially absorbed in this electrode is composed of two parts. One part results in the formation of the lithium-containing oxide and is irreversible. The other part generates potentially reversible, and thus usable, capacity.

Some other non-oxide materials have been found that also have an initial capacity that contains both irreversible and reversible components. In those cases some of the lithium, or other alkali metal, that is put into the electrode when it is charged forms an electrochemically irreversible product and remains trapped, and is not accessible within the potential range of the operation of the electrode subsequently.

Some of these alternative materials have been found in which the reversible part of the total capacity is very attractive. For example, having a significantly greater capacity then the lithium-carbons in lithium batteries. On the other hand, the irreversible capacity can be highly deleterious, for it requires the initial presence of extra alkali metal within the cell that cannot be used during subsequent cycling. This sacrificial alkali metal must come from somewhere inside the cell container, and the most obvious solution is to include additional positive electrode reactant material. In the case of lithium batteries, the currently used positive electrode materials have relatively low lithium capacities, roughly 120-140 mAh/g. Thus this is not a favorable solution, for it adds significantly to the overall mass and volume of the system. An advantage of this new invention is to overcome these deleterious effects of this irreversible capacity.

To illustrate the magnitude of the irreversible alkali metal consumption, theoretical data on the irreversible and potential reversible capacities of some simple binary oxides of potential use in lithium battery systems are shown in Table 1.

TABLE 1
Theoretical maximum reversible and irreversible
capacities of a number of simple oxides.

| | Reversible | Irreversible | Ratio |
|---|---|---|---|
| | Capacity | Capacity | Reversible/ |
| Material | mAh/g | mAh/g | Total |
| SnO | 875 | 398 | 0.69 |
| SnO₂ | 782 | 711 | 0.52 |
| ZnO | 493 | 659 | 0.43 |
| CdO | 605 | 417 | 0.59 |
| PbO | 540 | 240 | 0.69 |

An Example Demonstrating the Irreversible and Reversible Capacity of an Oxide Containing Tin

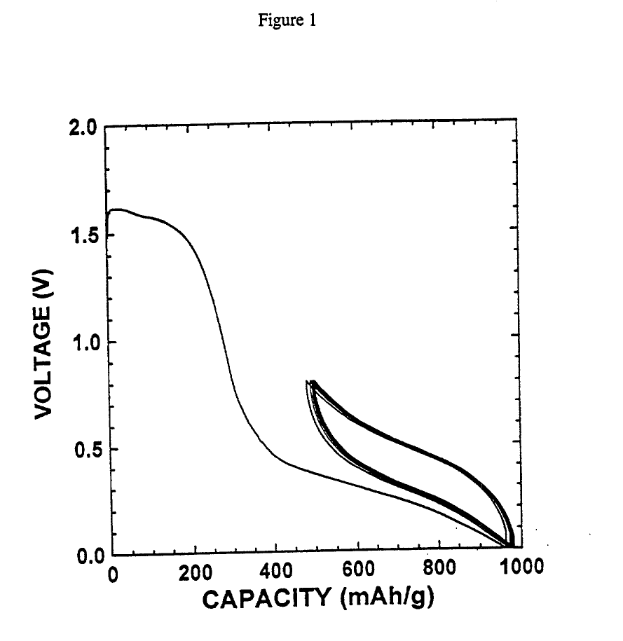

As a lithium-based example, experimental data for an oxide glass, Sn₂BPO₆, are shown in FIG. 1. The data are from “Key Factors Controlling the Reversibility of the Reaction of Lithium with SnO₂ and Sn₂BPO₆ Glass”, by I. A. Courtney and J. R. Dahn, J. Flectrochem. Soc. 144, 2943 (1997). It is seen that, although the initial lithiation of this material gave a capacity of about 980 mAh/g, the subsequent reversible capacity was only about 480 mAh/g.

The difference of about 500 mAh/g was irreversible, and resulted from the reaction of lithium with the initial oxide to form an electrochemically irreversible lithium-containing oxide.

### SUMMARY OF THE INVENTION

This invention provides for improved capacity of alkali metal batteries. This is due to a substantial improvement of the properties of the negative electrode. A number of otherwise attractive negative electrode materials suffer from a serious disadvantage due to their reaction with a large amount of extra alkali metal during the first charging cycle or cycles. This extra alkali metal cannot be recovered and employed during subsequent charge-discharge cycles. It therefore represents irreversible and unusable capacity in the negative electrode, which must be balanced by the presence of extra sacrificial capacity, with its concommitant mass and volume, in the positive electrode or elsewhere in the battery system, thus negatively affecting the properties of the battery as a whole.

By means of the methods taught in this invention the properties of such alkali metal battery negative electrodes can be substantially improved by performing one or more preliminary reactions, i.e. pre-treatment(s), or initial charging-discharging cycle or cycles, of the negative electrode prior to the final assembly of the battery.

These preliminary reactions are advantageous because they eliminate a portion, or all, of the irreversible capacity during later operation of the battery by consuming the irreversible reactants creating electrochemically irreversible products in the electrode structure prior to the final assembly of the battery by reaction with a material containing one or more alkali metals.

The result is that there is greatly reduced, or no, irreversible capacity during the subsequent normal operation of the battery because the one or more preliminary reactions create product materials in the electrode, a subset of which are electrochemically irreversible in the battery prior to its final assembly.

These one or more preliminary reactions can be done either by the use of one or more chemical reactants, or by the employment of an electrochemical cell, to supply the required irreversible extra alkali metal, or a combination of chemical and electrochemical means. It can also be done at several different electrical or chemical potential levels, and involve the use of multiple cycles. It can be performed on individual electrode materials, on combinations of materials, on electrode components, or on assembled electrodes.

It is an object of this invention to produce electrodes for alkali metal battery systems with reduced irreversible capacity.

It is a further object of this invention to reduce the need for the presence of additional alkali metal sources within the electrochemical cell.

It is a further object of this invention to provide a method to limit initial irreversible capacity by performing one or more preliminary reactions upon the negative electrode or components thereof, outside of and prior to the final assembly of the electrochemical cell.

It is a further object of this invention to provide a method to limit initial irreversible capacity by performing one or more preliminary reactions upon the negative electrode or components thereof, inside of the electrochemical cell prior to its final assembly.

It is a further object of this invention to perform one or more preliminary re actions either chemically or electrochemically, or a combination of the two.

### DETAILED DESCRIPTION OF THE FIGURES

FIG. 1 is a graph showing the relationship between the voltage and the capacity of Sn₂BPO₆ glass upon cycling in a lithium cell. Upon initial charging there is a capacity of 980 mAh/g, but a capacity of only about 480 mAh/g is found during the first discharge. The difference, about 500 mAh/g, is irreversible capacity loss. Subsequent cycles evidence only the reversible 480 mAh/g.

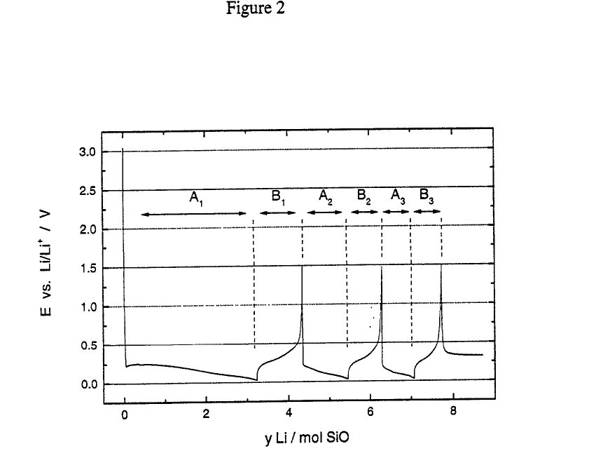

FIG. 2 is a graph showing the results of another lithium example, three discharge-charge cycles of SiO without a pre-lithiation charge-discharge cycle. A₁ represents the magnitude of the capacity upon the first charging cycle, and B₁ represents the magnitude of the capacity during the first discharge cycle. Likewise, A₂ and B₂ represent the magnitudes of the charging and discharging capacity in the second cycle, and A₃ and B₃ the corresponding values for the

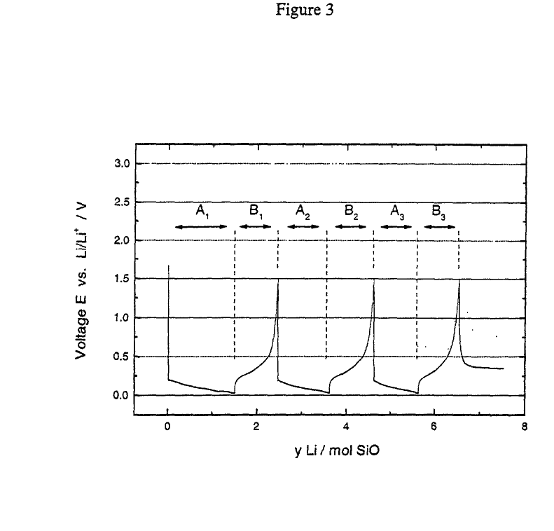

FIG. 3 is a graph showing the results of three discharge-charge cycles of SiO after a preliminary electrochemical pre-lithiation charge-discharge cycle. A₁ represents the magnitude of the capacity upon the first charging cycle, and B₁ represents the magnitude of the capacity during the first discharge cycle. Likewise, A₂ and B₂ represent the magnitudes of the charging and discharging capacity in the second cycle, and A₃ and B₃ the corresponding values for the third cycle.

### DETAILED DESCRIPTION OF THE INVENTION

This invention provides a method to limit the initial irreversible capacity in an alkali metal-based electrochemical cell, and thus the necessity for the presence of an additional alkali metal source material in the cell.

This can be accomplished simply and economically by performing the initial charge-discharge cycle or cycles of the negative electrode reactant material outside of the battery. Subsequently, this material is inserted into the final battery to operate as the negative electrode.

This external preliminary cycle, or cycles, can be done either chemically or electrochemically, or a combination of the two. There are two further possibilities. One is to perform the initial charge-discharge cycle, or cycles, upon a prepared electrode, and the other is to perform the preliminary charge-discharge cycle, or cycles, upon one or more of the components of the final electrode structure. In any of these approaches the electrode may be preconditioned as fully charged, fully discharged, or an intermediate state prior to incorporation into the final battery system.

As a lithium-based example, in order for the charging part of the pre-lithiation cycle to be done chemically, the electrode material must react with a chemical lithium source that has a lithium activity greater than that of the material to be lithiated. A number of materials have been used as chemical lithium sources for reactants that operate at relatively high potentials, such as those used as positive electrode materials in lithium systems. This can also, in principle, be done with negative electrode materials. The requirement is that the reaction potential of the lithium source must be lower than that of the material being lithiated in order to supply lithium to it. Likewise, during the discharge part of this pretreatment example, the reaction potential of the lithium source must be higher than that of the material being de-lithiated in order to remove lithium from it. Examples of well-known chemical lithium reactants and their reaction potentials are included in Table 2.

TABLE 2
Reaction potentials of some materials that can be
used for chemical lithiation and de-lithiation.

| Material | Volts vs Li/Li⁺ |
|---|---|
| LiBr | 3.54 |
| LiI | 2.79 |
| n-butyl lithium | 1.0 |
| LiBH₄ | 0.87 |
| LiH | 0.71 |
| Li₃N | 0.44 |

The other alternative is to perform the initial external charge-discharge cycle, or cycles, electrochemically. As mentioned above, there are also two possibilities for this approach.

One is to perform the initial charge-discharge cycle or cycles upon a normal electrode structure by inserting said structure into a simple electrochemical cell external to the final battery and to use an alkali metal or some other alkali metal-containing material with the appropriate polarity as the alkali metal source and sink. After passing current through the cell in order to cause the charge-discharge reaction of the alkali metal, with the electrode structure, the pretreated electrode is removed, and subsequently inserted into the battery. A variant would be to perform the initial alkali metal loading of the negative electrode structure in-situ within the cell, using an external alkali metal-providing electrode, prior to the final sealing of the cell. In any of these alternatives the electrode may be preconditioned as fully charged, fully discharged or an intermediate state, prior to final assembly.

The second possibility is to do the initial external electrochemical charge-discharge cycle or cycles on the primary electrode reactant, or on a combination of components, rather than upon the complete electrode.

This electrochemical pre-treatment can be done either galvanostatically or potentiostatically, or a combination of both.

Following this pre-treatment, there will be much less initial irreversible capacity during operation of the assembled battery.

The use of this invention thus makes a number of the oxides, alloys, and other convertible electrode materials much more attractive candidates for use in practical cells by reducing the deleterous irreversible reaction with an alkali metal in the battery system, the so-called irreversible capacity.

There are some advantages to the use of an electrochemical, rather than a chemical, pre-treatment cycle. One is that a full cycle, or cycles, of alkali metal reaction and extraction can be readily performed. This leaves the electrode material at a high potential, and therefore at a low alkali metal activity (content) such that it is less sensitive to air and water vapor and can be easily handled and inserted into the battery. This is more attractive for battery manufacture, as batteries are typically produced in the discharged state. Subsequently, during the first charging the alkali metal is transferred from the positive electrode to the negative electrode. This raises the potential of the positive electrode, and reduces that of the negative electrode, preparing the battery for use as a current source.

Although the above discussion has implied that the initial pre-treatment cycle is to be done galvanostatically and to be performed only once, other variations are possible. For example, the first charge-discharge cycle could include both galvanostatic and potentiostatic components. Another variation would be to perform this initial pre-treatment using more than one cycle in order to increase the thoroughness of the reduction of the irreversible capacity.

This method can be utilized at elevated temperatures as well as at ambient temperatures. In some cases, this will increase the kinetics, or result in other advantages.

It is also not necessary that the electrolyte employed for the alkali metal pre-treatment be the same as that utilized in the final electrochemical battery.

It is not necessary that all of the irreversible capacity be ameliorated by the pre-treatment reactions or charge-discharge cycle or cycles. Even a partial solution to this problem may be useful in practical applications.

It is also possible that the alkali metal involved in the pre-treatment is different from the alkali metal that is involved in subsequent reversible reactions of the electrode in the battery. For example, lithium, which is more reactive and also has a lower atomic weight, might be used to pre-treat a convertible negative electrode intended for use in a sodium battery.

Although any reduction in the amount of irreversible capacity is useful, larger amounts will have more significant effects upon the properties and attractiveness of the resultant batteries, especially in cases in which the applications are either volume- or weight-sensitive. By means of this invention, amelioration of well over half of the irreversible capacity is easily attainable.

### EXAMPLE

An example of the use of this invention is the performance of an external electrochemical lithium charge-discharge cycle on SiO. An electrode was constructed by placing of a 30 micrometer thick layer of SiO, plus a binder and electronically conducting carbon in the ratio (85/10/5), on a copper foil substrate by tape casting. This was followed by heating to about 110° C. for 24 hours to drive off volatile parts of the binder. This electrode was then inserted into a simple air-tight coffee-bag type of cell with a fiberglass separator containing a liquid electrolyte (LiPF₆ in an EC-DEC solution) and also a lithium counter electrode.

Current was passed through the cell at a rate of 0.1 mA/cm² for some 74 hours, until the potential reached 25 mV vs Li. This introduced 3.24 moles of lithium per mol of SiO. The direction of the current was then reversed until the potential reached 3 V vs Li. This caused the removal of the reversible lithium, but not the irreversible lithium. The amount of electrical charge necessary to reach this voltage limit converted to 1.1 mol of reversible lithium extracted. This extracted lithium could then be further cycled. The remaining 2.13 mols of lithium introduced into the electrode was irreversible and could not be utilized. This is shown in FIG. 2.

A similar experiment was conducted upon a cell in which the SiO negative electrode had been given the same first charge-discharge cycle electrochemical galvanostatic lithiation treatment as in the case described above. However, in this second case the electrode was then removed from this initial electrochemical cell, and inserted into a “final” cell. The properties of the “final” cell were then measured under similar galvanostatic cycling conditions. The results are shown in FIG. 3 and Table 4. It can readily be seen that the large initial irreversible capacity visible in the cell of FIG. 2 has been greatly reduced in the second case, from 2.13 mols of irreversible lithium per mol of SiO to only 0.55 mols of irreversible lithium per mol of SiO, illustrating the advantage of this method.

FIGS. 2 and 3 can more readily be understood by means of the following tabular data. The capacity data for each of the charge and discharge cycles of this material without pre-lithiation are included in Table 3.

The capacity data for each of the charge and discharge cycles of this material after electrochemical pre-lithiation are included in Table 4.

TABLE 3
Capacity values measured during cycling SiO electrode without
pre-lithiation charge-discharge cycle.

| Cycle | y Li in Li_{y}SiO | Capacity/mAh/g |
|---|---|---|
| First charge | +3.24 | +1969 |
| First discharge | −1.11 | −676 |
| Second charge | +1.12 | +679 |
| Second discharge | −0.83 | −508 |
| Third charge | +0.78 | +472 |
| Third discharge | −0.66 | −403 |

TABLE 4
Capacity values measured during cycling SiO electrode after
electrochemical pre-lithiation charge-discharge cycle.

| Cycle | y Li in Li_{y}SiO | Capacity/mAh/g |
|---|---|---|
| First charge | +1.51 | +920 |
| First discharge | −0.96 | −582 |
| Second charge | +1.16 | +704 |
| Second discharge | −1.00 | −606 |
| Third charge | +1.02 | +620 |
| Third discharge | −0.91 | −551 |

Other Embodiments of the Invention

There are many preferred embodiments of the present invention. These include the following.

A method to form an electrode for an alkali metal battery by internal chemical preliminary reactions or pre-treatment; a method to form an electrode for an alkali metal battery by means of internal electrochemical preliminary reactions or pre-treatment; a method to process a negative electrode material for an alkali metal battery by external chemical preliminary reactions or pre-treatment; a method to process a negative electrode material for an alkali metal battery by means of external electrochemical preliminary reactions or pre-treatment; an electrode for use in an alkali metal battery, said electrode containing the alkali metal introduced chemically external to the final electrochemical cell, such that the initial irreversible capacity is greatly reduced; an electrode for use in an alkali metal battery, said electrode comprising the alkali metal introduced electrochemically in a cell other than the final electrochemical cell, such that the initial irreversible capacity is greatly reduced; an electrode for use in an alkali metal battery, said electrode containing one or more component materials into which the alkali metal was introduced chemically externally prior to the final assembly, such that the initial irreversible capacity is greatly reduced; an electrode for use in an alkali metal battery, said electrode containing one or more component materials into which the alkali metal was introduced electrochemically externally prior to the final assembly, such that the initial irreversible capacity is greatly reduced; an alkali metal battery containing a negative electrode, said electrode comprising the alkali metal introduced electrochemically in a cell other than the final electrochemical cell, such that the initial irreversible capacity is greatly reduced; an alkali metal battery containing a negative electrode, said electrode containing one or more component materials into which the alkali metal was introduced chemically externally prior to the final assembly, such that the initial irreversible capacity is greatly reduced, an alkali metal battery containing a negative electrode, said electrode containing one or more component materials into which the alkali metal was introduced electrochemically externally prior to the final assembly, such that the initial irreversible capacity is greatly reduced.

While this invention has been described in terms of certain embodiments and with reference to a specific example, it is not intended to be limited by them, and it will be apparent to one skilled in the art that various variations and modifications can be made without departing from the spirit and scope thereof.

Abstract

A method to reduce the initial irreversible capacity in an alkali metal-based electrochemical cell, and thus the necessity for the presence of additional alkali metal source material in the cell comprising one or more preliminary reactions performed by either electrochemical or chemical means.

What is claimed is:

1. A method to produce a rechargeable battery in which the electroactive species is an alkali metal comprising the step of performing one or more preliminary reactions of the negative electrode with a material containing said alkali metal prior to final assembly of said rechargeable battery, said one or more preliminary reactions producing a plurality of product materials in said negative electrode, wherein at least one of said product materials is electrochemically irreversible in said rechargeable battery.

2. The method as described in claim 1, wherein said alkali metal is lithium.

3. The method as described in claim 1, wherein said one or more preliminary reactions are electrochemical.

4. The method as described in claim 2, wherein said one or more preliminary reactions are electrochemical.

5. The method as described in claim 1, wherein said one or more preliminary reactions are chemical.

6. The method as described in claim 2, wherein said one or more preliminary reactions are chemical.

7. The method as described in claim 1, wherein said one or more preliminary reactions are comprised of both chemical and electrochemical components.

8. The method as described in claim 2, wherein said one or more preliminary reactions are comprised of both chemical and electrochemical components.

9. The method as described in claim 3, wherein at least one of said one or more preliminary reactions is performed external to said rechargeable battery.

10. The method as described in claim 4, wherein at least one of said one or more preliminary reactions is performed external to said rechargeable battery.

11. The method as described in claim 5, wherein at least one of said one or more preliminary reactions is performed external to said rechargeable battery.

12. The method as described in claim 6, wherein at least one of said one or more preliminary reactions is performed external to said rechargeable battery.

13. The method as described in claim 7, wherein at least one of said one or more preliminary reactions is performed external to said rechargeable battery.

14. The method as described in claim 8, wherein at least one of said one or more preliminary reactions is performed external to said rechargeable battery.

15. The method as described in claim 5, wherein at least one of said one or more preliminary reactions is performed internal to said rechargeable battery.

16. The method as described in claim 6, wherein at least one of said one or more preliminary reactions is performed internal to said rechargeable battery.

17. A first material that can be used in the negative electrode of a rechargeable battery in which the electroactive species is an alkali metal produced by performing one or more preliminary reactions of said first material with a second material containing said alkali metal prior to final assembly of said rechargeable battery, said one or more preliminary reactions producing a plurality of products in said first material, wherein at least one of said products is electrochemically irreversible in said rechargeable battery.

18. The first material as described in claim 17, wherein said alkali metal is lithium.

19. The first material as described in claim 17, wherein said one or more preliminary reactions are electrochemical.

20. The first material as described in claim 18, wherein said one or more preliminary reactions are electrochemical.

21. The first material as described in claim 17, wherein said one or more preliminary reactions are chemical.

22. The first material as described in claim 18, wherein said one or more preliminary reactions are chemical.

23. The first material as described in claim 17, wherein said one or more preliminary reactions are comprised of both chemical and electrochemical components.

24. The first material as described in claim 18, wherein said one or more preliminary reactions are comprised of both chemical and electrochemical components.

25. The first material as described in claim 19, wherein at least one of said one or more preliminary reactions is performed external to said rechargeable battery.

26. The first material as described in claim 20, wherein at least one of said one or more preliminary reactions is performed external to said rechargeable battery.

27. The first material as described in claim 21, wherein at least one of said one or more preliminary reactions is performed external to said rechargeable battery.

28. The first material as described in claim 22, wherein at least one of said one or more preliminary reactions is performed external to said rechargeable battery.

29. The first material as described in claim 23, wherein at least one of said one or more preliminary reactions is performed external to said rechargeable battery.

30. The first material as described in claim 24, wherein at least one of said one or more preliminary reactions is performed external to said rechargeable battery.

31. The first material as described in claim 21, wherein at least one of said one or more preliminary reactions is performed internal to said rechargeable battery.

32. The first material as described in claim 22, wherein at least one of said one or more preliminary reactions is performed internal to said rechargeable battery.

33. A rechargeable battery in which the electroactive species is an alkali metal containing a positive electrode, a negative electrode and an electrolyte, wherein said negative electrode contains one or more phases which are electrochemically irreversible phases produced by the use of one or more preliminary reactions of said negative electrode with a material containing said alkali metal prior to final assembly of said rechargeable battery.

34. A rechargeable battery as described in claim 33, wherein said alkali metal is lithium.

35. A rechargeable battery as described in claim 33, wherein said one or more preliminary reactions are electrochemical.

36. A rechargeable battery as described in claim 34, wherein said one or more preliminary reactions are electrochemical.

37. A rechargeable battery as described in claim 33, wherein said one or more preliminary reactions are chemical.

38. A rechargeable battery as described in claim 34, wherein said one or more preliminary reactions are chemical.

39. A rechargeable battery as described in claim 33, wherein said one or more preliminary reactions are comprised of both chemical and electrochemical components.

40. A rechargeable battery as described in claim 34, wherein said one or more preliminary reactions are comprised of both chemical and electrochemical components.

41. A rechargeable battery as described in claim 35, wherein at least one of said one or more preliminary reactions was performed external to said rechargeable battery .

42. A rechargeable battery as described in claim 36, wherein at least one of said one or more preliminary reactions was performed external to said rechargeable battery.

43. A rechargeable battery as described in claim 37, wherein at least one of said one or more preliminary reactions was performed external to said rechargeable battery.

44. A rechargeable battery as described in claim 38, wherein at least one of said one or more preliminary reactions was performed external to said rechargeable battery.

45. A rechargeable battery as described in claim 39, wherein at least one of said one or more preliminary reactions was performed external to said rechargeable battery.

46. A rechargeable battery as described in claim 40, wherein at least one of said one or more preliminary reactions was performed external to said rechargeable battery.

47. A rechargeable battery as described in claim 37, wherein at least one of said one or more preliminary reactions was performed internal to said rechargeable battery.

48. A rechargeable battery as described in claim 38, wherein at least one of said one or more preliminary reactions was performed internal to said rechargeable battery.

49. A rechargeable battery in which the electroactive species is a first alkali metal containing a positive electrode, a negative electrode and an electrolyte, wherein said negative electrode contains one or more phases which are electrochemically irreversible in said rechargeable battery, produced by use of one or more preliminary reactions of said negative electrode with a material containing a second alkali metal prior to final assembly of said rechargeable battery.

50. A rechargeable battery as described in claim 49, wherein said one or more preliminary reactions are electrochemical.

51. A rechargeable battery as described in claim 49, wherein said one or more preliminary reactions are chemical.

52. A rechargeable battery as described in claim 49, wherein said one or more preliminary reactions are comprised of both chemical and electrochemical components.

53. A rechargeable battery as described in claim 50, wherein at least one of said one or more preliminary reactions was performed external to said rechargeable battery.

54. A rechargeable battery as described in claim 51, wherein at least one of said one or more preliminary reactions was performed external to said rechargeable battery.

55. A rechargeable battery as described in claim 52, wherein at least one of said one or more preliminary reactions was performed external to said rechargeable battery.

56. A rechargeable battery as described in claim 51, wherein at least one of said one or more preliminary reactions was performed internal to said rechargeable battery.

57. The method as described in claim 1, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

58. The method as described in claim 2, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

59. The method as described in claim 3, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

60. The method as described in claim 4, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

61. The method as described in claim 5, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

62. The method as described in claim 6, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

63. The first material as described in claim 17, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

64. The first material as described in claim 18, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

65. The first material as described in claim 19, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

66. The first material as described in claim 20, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

67. The first material as described in claim 21, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

68. The first material as described in claim 22, wherein said at least one of the electrochemically irreversible in said rechargeable battery product materials produced by said one or more preliminary reactions is greater than the amount of said at least one electrochemically irreversible in said rechargeable battery product materials produced electrochemically in said rechargeable battery during normal operation after final assembly.

69. A rechargeable battery as described in claim 33, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

70. A rechargeable battery as described in claim 34, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

71. A rechargeable battery as described in claim 35, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

72. A rechargeable battery as described in claim 36, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

73. A rechargeable battery as described in claim 37, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

74. A rechargeable battery as described in claim 38, wherein said at least one of the electrochemically irreversible in said rechargeable battery phases produced by said one or more preliminary reactions is greater than the amount of said at least one electrochemically irreversible in said rechargeable battery phases produced electrochemically in said rechargeable battery during normal operation after final assembly.

75. A rechargeable battery as described in claim 49, wherein said one or more of the electrochemically irreversible in said rechargeable battery phases produced by said one or more preliminary reactions is greater than the amount of said one or more electrochemically irreversible in said rechargeable battery phases produced electrochemically in said rechargeable battery during normal operation after final assembly.

76. A rechargeable battery as described in claim 50, wherein said one or more of the electrochemically irreversible in said rechargeable battery phases produced by said one or more preliminary reactions is greater than the amount of said one or more electrochemically irreversible in said rechargeable battery phases produced electrochemically in said rechargeable battery during normal operation after final assembly.

77. A rechargeable battery as described in claim 51, wherein said one or more of the electrochemically irreversible in said rechargeable battery phases produced by said one or more preliminary reactions is greater than the amount of said one or more electrochemically irreversible in said rechargeable battery phases produced electrochemically in said rechargeable battery during normal operation after final assembly.
